(19) United States
(12) Patent Application Publication
(10) Pub. No.: US 2002/0033901 A1
(43) Pub. Date: Mar. 21, 2002

(54) Adaptive pre-processing method for motion estimation

(76) Inventor: Francois Martin, Paris (FR)

Correspondence Address: Corporate Patent Counsel, U.S. Philips Corporation, 580 White Plains Road, Tarrytown, NY, 10591, US

(21) Appl. No.: 09/899,878

(22) Filed: Jul. 6, 2001

(30) Foreign Application Priority Data
Jul. 13, 2000 (EP) 00402026.9

(51) Int. Cl. H04N 5/14; H04N 9/64; H04N 7/12

(52) U.S. Cl. 348/699; 375/240.16; 375/240.12; 375/240.29

(57) ABSTRACT

The present invention relates to a method of processing an input digital video signal (IS) so as to provide a modified digital video signal (MS) for a motion estimation step (ME). Said processing method comprises the steps of computing (HIS) a histogram (h) of original values associated with pixels belonging to a video frame contained in said input digital video signal, analyzing (ANA) the histogram to provide histogram parameters (hp), and correcting (COR) the original pixel values on the basis of the histogram parameters to provide modified pixel values, which yields the modified digital video signal to be used by the motion estimation step. If required, this processing method may also comprise a step of filtering (FIL) the modified digital video signal so as to provide a filtered modified digital video signal (FMS) for the motion estimation step. Such a processing method is adaptive to the content of the input digital video signal and allows the motion estimation step to provide better motion vectors for the purpose of encoding. Use: video encoder

The present invention relates to a method of processing an input digital video signal comprising video frames so as to provide a modified digital video signal for a motion estimation step. The present invention also relates also to a device corresponding to said method of processing.

Such a processing method may be used, for example, as a pre-processing before an MPEG-2 or an MPEG-4 video encoding.

A processing device of the above kind is described in the U.S. Pat. No. 5,990,962. Said processing device is used in a video encoding apparatus and comprises a motion compensation prediction estimating circuit for detecting a change from a current picture and a past picture to generate change data and a filter for deforming the current picture in accordance with the change data generated by the motion compensation prediction estimating circuit such that a deformed current picture is sent to a motion compensation prediction encoding section of the video encoding apparatus in order to be encoded.

It is an object of the invention to provide a method of processing an input digital video signal which is both easy to implement and cost-effective. The invention takes the following aspects into consideration.

The processing method according to the background art is rather complex as it needs both a comparison operation of a current picture with a past picture to generate change data and a filtering operation to deform the current picture in accordance with the change data. Said operations of comparison and filtering are expensive in terms of memory capacity and central processing units (CPU) burden.

To solve this problem, the processing method in accordance with the invention is characterized in that it comprises the steps of:

computing a histogram of original values associated with pixels belonging to a video frame,

analyzing the histogram to provide histogram parameters, and

correcting the original pixel values on the basis of the histogram parameters to provide modified pixel values, which yields the modified digital video signal to be used by the motion estimation step.

Said processing method is adaptive to the content of the input digital video signal and more particularly to the histogram of the luminance or chrominance components of a video frame contained in said input digital video signal. As a consequence, said method needs neither a knowledge of the past video frame nor a filtering step, which makes it both simple and efficient.

Moreover, this method is particularly efficient for certain types of sequences of video frames such as, for example, dark sequences or sequences with a large variation of luminance from a given video frame to the next one, said large variation of luminance being caused by a flash or a fade. For these types of sequences, the usual motion estimation methods are not capable of providing suitable motion vectors. As a consequence, the motion estimation and the encoding of the input digital video signal are not performed properly. The processing method in accordance with the invention provides a modified digital video signal which allows the motion estimation step to determine better motion vectors. As a consequence, said processing method leads to an improvement of the compression efficiency and of the image quality.

These and other aspects of the invention will be apparent from and elucidated with reference to the embodiments described hereinafter.

The present invention will now be described, by way of example, with reference to the accompanying drawings, wherein:

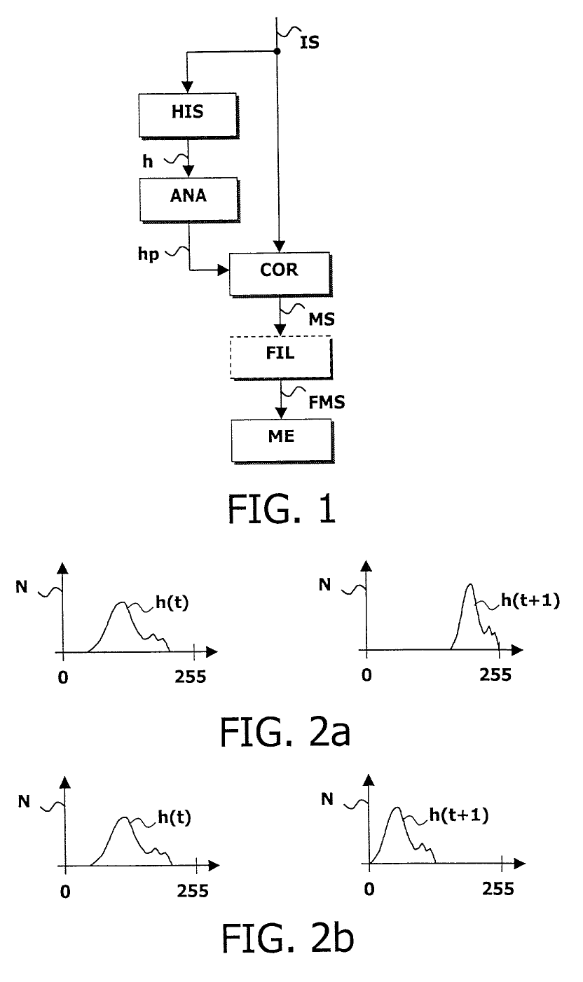

FIG. 1 is a block diagram corresponding to a processing method in accordance with the invention,

FIG. 2a shows the evolution of a luminance histogram for a sequence in which a flash occurs,

FIG. 2b shows the evolution of a luminance histogram for a sequence containing a fade to dark,

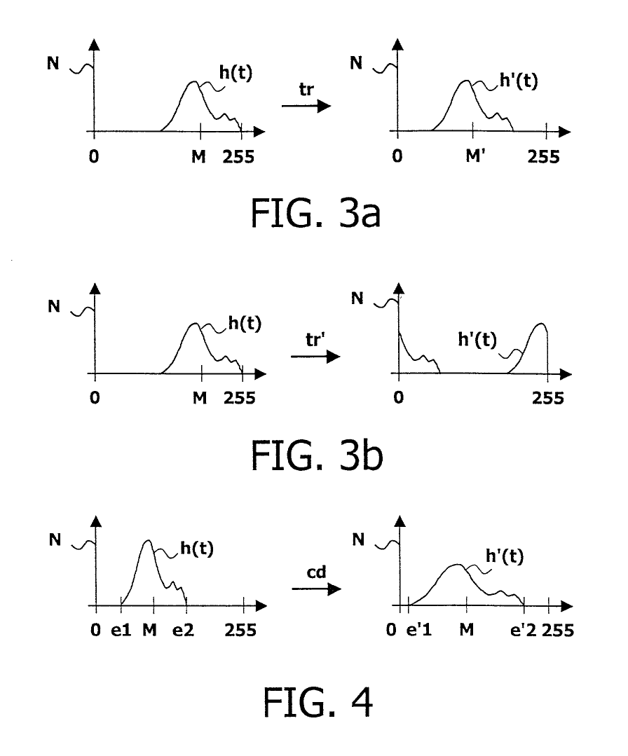

FIG. 3a shows an example of a translation operation of the histogram in the method in accordance with the invention,

FIG. 3b is a particular case of the previous example where the histogram is divided into two portions,

FIG. 4 shows an example of a width variation operation of the histogram in the method in accordance with the invention,

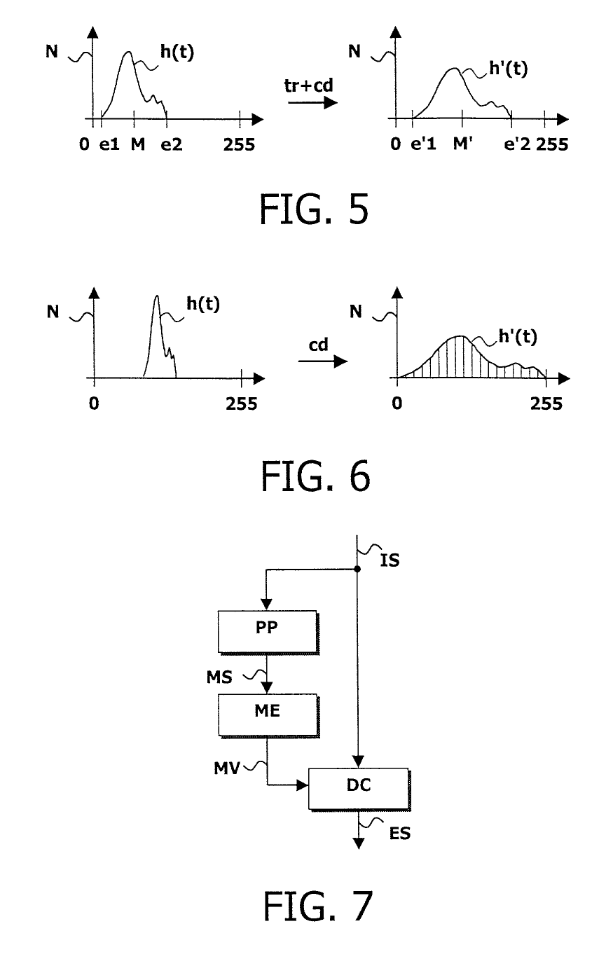

FIG. 5 shows an example of a combination of a translation operation with a width variation operation of the histogram in the method in accordance with the invention,

FIG. 6 shows the evolution of the histogram after a correction step and a filtering step in the method in accordance with the invention, and

FIG. 7 is a block diagram corresponding to an encoding method in accordance with the invention.

The present invention relates to a method of processing an input digital video signal (IS) so as to provide a modified digital video signal (MS) for a motion estimation step (ME). The aim of the motion estimation step is to compute motion vectors between two video frames. For certain types of sequences of video frames, such as sequences with a large variation of the luminance values from one video frame to another, the motion estimation step is not capable of providing suitable motion vectors.

The processing method in accordance with the invention is adaptive to the content of the input digital video signal in order to provide a modified digital video signal and allows an improvement of the motion vector estimation.

FIG. 1 is a block diagram corresponding to the processing method. Said processing method comprises the steps of:

computing (HIS) a histogram (h) of original values associated with pixels belonging to a video frame contained in the input digital video signal,

analyzing (ANA) the histogram to provide histogram parameters (hp), and

correcting (COR) the original pixel values on the basis of the histogram parameters to provide modified pixel values, which yields the modified digital video signal to be used by the motion estimation step.

If required, the processing method may also comprise a step of filtering (FIL) the modified digital video signal to provide a filtered modified digital video signal (FMS) for the motion estimation step.

In a preferred variant, the processing method is based on the calculation of a histogram of luminance values associated with pixels belonging to a video frame. A luminance histogram is a representation of the accumulation of luminance pixels in a video frame for each luminance value from 0 to 255.

It should be noted that the computing step can be applied to the chrominance values associated with pixels or to a combination of the luminance and chrominance values without going beyond the scope of the invention. In this preferred variant, the computing step is applied to the whole video frame but it can also be applied to a portion of said video frame, for example a half of the video frame, in order to save memory cost.

Once the luminance histogram has been provided by the computing step, the processing method analyzes said histogram to decide which type of correction to perform and when this has to be performed, which makes the method adaptive to the content of a video frame. A temporal analysis of the histograms corresponding to consecutive video frames shows the luminance evolution of a sequence of video frames and allows the detection of the video frames where a usual motion estimation method will be inefficient. FIGS. 2a and 2b show the evolution of a luminance histogram for two specific sequences of video frames, a sequence in which a flash occurs, and a sequence containing a fade to dark, respectively.

It can be observed in FIG. 2a that the luminance histogram (h(t+1)) of a video frame where a flash occurs, is translated towards the high luminance values in comparison with the histogram (h(t)) of the previous video frame without the flash. On the contrary, it can be observed in FIG. 2b that the luminance histogram (h(t+1)) of a video frame contained in a video sequence with a fade to dark is translated towards the low luminance values in comparison with the histogram (h(t)) of the previous video frame of said sequence. Moreover, it can be observed in both cases that the width of the luminance histogram (h(t+1)) of a video frame is shortened in comparison with the histogram (h(t)) of the previous video frame of the same sequence.

To overcome these problems, a correction step of the luminance values is necessary. The correction step of the processing method in accordance with the invention is implemented using two simple operations.

The first operation corresponds to a translation of the histogram of the luminance as described with reference to FIGS. 3a and 3b. According to this translation sub-step, the original luminance value Y(x, y, t) of a pixel (x, y) belonging to a current video frame F(t) is subjected to a translation by a coefficient kt, giving a modified luminance value Y′(x, y, t), which is as follows:

Y′(x,y,t)=Y(x,y,t)+kt

FIG. 3a shows an example of a translation operation (tr) according to the invention. The mean value of the luminance over the current video frame is equal to M. The original luminance values Y(x, y, t) of pixels belonging to said video frame are then translated in such a way that the mean value of the modified luminance values Y′(x, y, t) over the current video frame becomes M′. As a consequence, kt is equal to the difference between M′ and M. In a specific variant of the invention, M′ is equal to 128 or is close to this particular value in order to center the luminance histogram h′(t) corresponding to the modified luminance values Y′(x, y, t).

FIG. 3bshows another specific variant where M′ is equal or close to zero. In that particular case, the modified luminance value Y′(x, y, t) computed by the translation sub-step (tr′) can be negative. When said modified luminance value Y′(x, y, t) is negative, a fixed translation of 256 is performed in order to keep the modified luminance value Y′(x, y, t) within the range [0-255]. The result is a histogram divided into two portions.

In the same manner, if the modified luminance value Y′(x, y, t) computed by the translation sub-step (tr) is higher than 255, a fixed translation of −256 is applied to keep the modified luminance value Y′(x, y, t) within the range [0-255].

The second operation corresponds to a width variation (cd) of the luminance histogram, which can be either a dilation or a contraction of said histogram. FIG. 4 shows an example of a dilation operation of the histogram in the method in accordance with the invention. According to this width variation sub-step, the original luminance value Y(x, y, t) of a pixel (x, y) belonging to a current video frame F(t) is multiplied by a coefficient kw, giving a modified luminance value Y′(x, y, t), which is as follows:

Y′(x,y,t)=kw.(Y(x,y,t)−M)+M

where M is the mean of the original luminance values over the whole video frame.

If the coefficient kw is greater than 1; there is a dilation of the luminance histogram otherwise there is a contraction of the histogram. Such an operation is particularly advantageous in the case of a dilation when the initial width of the histogram is defined by the interval [e1,e2], yielding a modified interval [e′l, e′2] after the dilation operation. The modified luminance values of the pixels are then spread over a much larger range and the computing of motion vectors by a motion estimation method is simplified. In the preferred variant, the coefficient kw is computed as follows:

$$kw = \frac{{e}^{′} 2 - {e}^{′} 1}{e2 - e1}$$

where [e′1,e′2] is the modified luminance value interval determined, for example, by the user.

Said coefficient kw can also be fixed by the user or by any other method without going beyond the scope of this invention.

In the same manner as in the translation sub-step, the modified luminance value Y′(x, y, t) is kept within the range [0-255].

Both operations of translation (tr) and width variation (cd) can also be combined in order to have a more efficient correction. FIG. 5 shows an example of a combination of a translation operation with a dilation operation of the histogram in the method in accordance with the invention. According to these operations, the original luminance value Y(x, y, t) of a pixel (x, y) belonging to a current video frame F(t) is multiplied by a coefficient kw and the result is translated by a value M′, giving a modified luminance value Y′(x, y, t), which is as follows:

Y′(x, y, t)=kw.(Y(x,y,t)−M)+M′

where M is the mean of the original luminance values over the whole video frame and M′ is the mean of the modified luminance values over the whole video frame determined by the user.

It should be noted that more complex operations are conceivable other than those described by way of examples without going beyond the scope of the present invention.

Finally, a filtering step can be performed, more especially after a dilation operation of the histogram. This is particularly useful when the coefficient kw is higher than 2. In that case, the histogram is discontinuous, the accumulation of luminance pixels for certain luminance values being equal to zero as is shown in FIG. 6, and the filtering step allows the histogram curve to be smoothed by using, for example, an interpolation filter.

Such a processing method is implemented in an integrated circuit, which is suitably programmed, and which is integrated into, for example, a video encoder. A set of instructions contained, for example, in a computer programming memory may cause the integrated circuit to carry out the different steps of the processing method. The set of instructions may be loaded into the programming memory by reading a data carrier such as, for example, a disk. The set of instructions can also be made available by a service provider via a communication network such as, for example, the Internet.

The present invention also relates to a method of encoding an input digital video signal (IS) so as to provide an encoded digital video signal (ES).

FIG. 7 is a block diagram corresponding to said encoding method, which comprises the steps of:

pre-processing (PP) an input digital video signal (IS) so as to provide a modified digital video signal (MS),

estimating motion (ME) from the modified digital video signal so as to provide motion vectors (MV),

compressing (DC) the input digital video signal from the motion vectors so as to provide an encoded digital video signal (ES),

The encoding method in accordance with the invention is such that the pre-processing step comprises the sub-steps of:

computing (HIS) a histogram (h) of original values associated with pixels belonging to a video frame,

analyzing (ANA) the histogram to provide histogram parameters (hp), and

correcting (COR) the original pixel values on the basis of the histogram parameters to provide modified pixel values, which yields the modified digital video signal to be used by the motion estimation step.

Finally, the present invention relates to a video encoder corresponding to the above described FIG. 7 and method of encoding.

It will be obvious that the verb “to comprise” and its conjugation does not exclude the presence of other steps or elements than those defined in any claim. The word “a” or “an” preceding an element or step does not exclude the presence of a plurality of said elements or steps. Any reference sign in the following claims should not be construed as limiting the claim.

1. A method of processing an input digital video signal (IS) comprising video frames so as to provide a modified digital video signal (MS) for a motion estimation step (ME), characterized in that said processing method comprises the steps of:
computing (HIS) a histogram (h) of original values associated with pixels belonging to a video frame,
analyzing (ANA) the histogram to provide histogram parameters (hp), and
correcting (COR) the original pixel values on the basis of the histogram parameters to provide modified pixel values, which yields the modified digital video signal to be used by the motion estimation step.

2. A method of processing as claimed in claim 1, characterized in that the analysis step (ANA) comprises a sub-step of calculating a translation parameter of the histogram, and the correction step is adapted to derive the modified pixel values from a sum of the original pixel values and the translation parameter.

3. A method of processing as claimed in claim 1, characterized in that the analysis step (ANA) comprises a sub-step of calculating a width variation parameter of the histogram, and the correction step is adapted to derive the modified pixel values from a product of the original pixel values and the width variation parameter.

4. A method of processing as claimed in claim 3, characterized in that it comprises a step of filtering (FIL) the modified digital video signal (MS) so as to provide a filtered modified digital video signal (FMS) for the motion estimation step.

5. A method of encoding an input digital video signal (IS) comprising the steps of:
pre-processing (PP) the input digital video signal so as to provide a modified digital video signal (MS),
estimating motion (ME) from the modified digital video signal so as to provide motion vectors (MV),
compressing (DC) the input digital video signal from the motion vectors so as to provide an encoded digital video signal (ES), characterized in that the pre-processing step comprises the sub-steps of:
computing (HIS) a histogram (h) of original values associated with pixels belonging to a video frame,
analyzing (ANA) the histogram to provide histogram parameters (hp), and
correcting (COR) the original pixel values on the basis of the histogram parameters to provide modified pixel values, which yields the modified digital video signal to be used by the motion estimation step.

6. A video encoder comprising:
a pre-processing device (PP) for receiving an input digital video signal (IS) and for supplying a modified digital video signal (MS),
a motion estimator (ME) for receiving the modified digital video signal and for supplying motion vectors (MV),
a data compressor (DC) for receiving the input digital video signal and for deriving an encoded digital video signal (ES) from the motion vectors, characterized in that the pre-processing device comprises:
means for computing (HIS) a histogram (h) of original values associated with pixels belonging to a video frame,
means for analyzing (ANA) the histogram in order to provide histogram parameters (hp), and
means for correcting (COR) the original pixel values on the basis of the histogram parameters and adapted to provide modified pixel values, which yields the modified digital video signal for the motion estimator.

7. A computer program product for a video encoder that comprises a set of instructions, which, when loaded into the video encoder, causes the video encoder to carry out the processing method as claimed in claims 1 to 4.
